(19) United States
(12) Patent Application Publication
(10) Pub. No.: US 2010/0326391 A1
(43) Pub. Date: Dec. 30, 2010

(54) Cylinder Rings

(76) Inventors: Robert Charles Mierisch, Redwood City, CA (US); Andrew Leslie Murdoch, Redwood City, CA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/823,038

(22) Filed: Jun. 24, 2010

Related U.S. Application Data
(60) Provisional application No. 61/219,768, filed on Jun. 24, 2009.

(51) Int. Cl. F02F 3/00; F02F 1/00

(52) U.S. Cl. 123/193.6; 123/193.2

(57) ABSTRACT

In some aspects, there is provided an apparatus. The apparatus may include a cylinder for a reciprocating steam engine, wherein the cylinder further comprises a cylinder ring. The cylinder ring may include a face and a heel, wherein the face makes contact with a piston of the reciprocating steam engine, wherein the heel inserts into a cavity formed on an inner surface of the cylinder, wherein the cavity is positioned in a region of the inner surface proximate to a top of the piston, when the piston is at a bottom dead center position. Related apparatus and methods are also described.

### CROSS REFERENCE TO RELATED APPLICATION

This application claims the benefit under 35 U.S.C. §119(e) of the following provisional application, which is incorporated herein by reference in its entirety: U.S. Ser. No. 61/219,768, entitled “Cylinder Rings for Engines,” filed Jun. 24, 2009.

### FIELD

The present disclosure generally relates to engines and, in particular, steam engines.

### BACKGROUND

A steam engine performs work using steam. Generally, the process of using steam to perform work begins by heating water to generate steam. The steam is then used to drive an engine which performs work, such as for example by driving a piston to power machinery, generate electricity, and the like.

### SUMMARY

In some aspects, there is provided an apparatus. The apparatus may include a cylinder for a reciprocating steam engine, wherein the cylinder further comprises a cylinder ring. The cylinder ring may include a face and a heel, wherein the face makes contact with a piston of the reciprocating steam engine, wherein the heel inserts into a cavity formed on an inner surface of the cylinder, wherein the cavity is positioned in a region of the inner surface proximate to a top of the piston, when the piston is at a bottom dead center position.

In another aspect, there is provided an apparatus comprising a cylinder for a reciprocating steam engine. The cylinder may include an inner surface. The cylinder may further include an insulating ring and an annular cooling chamber. The annular cooling chamber may extend around the inner surface of the cylinder and contact a region of the inner surface of the cylinder, wherein the region of the inner surface is proximate to a top of the piston, when the piston is at a bottom dead center position.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### BRIEF DESCRIPTION OF THE DRAWINGS

In the drawings,

FIG. 1 depicts a cross-section view of a portion of a steam engine including cylinder rings and a ring holder;

FIG. 2 depicts a closer view of a portion of the cylinder rings and the ring holder depicted at FIG. 1;

FIGS. 3A-3B depict examples of the cylinder rings and the ring holder;

FIG. 4 depicts an example of the cylinder rings implemented using springs; and

FIG. 5 depicts an example of a cylinder cooled using an annular cooling region.

Like labels are used to refer to same or similar items in the drawings.

### DETAILED DESCRIPTION

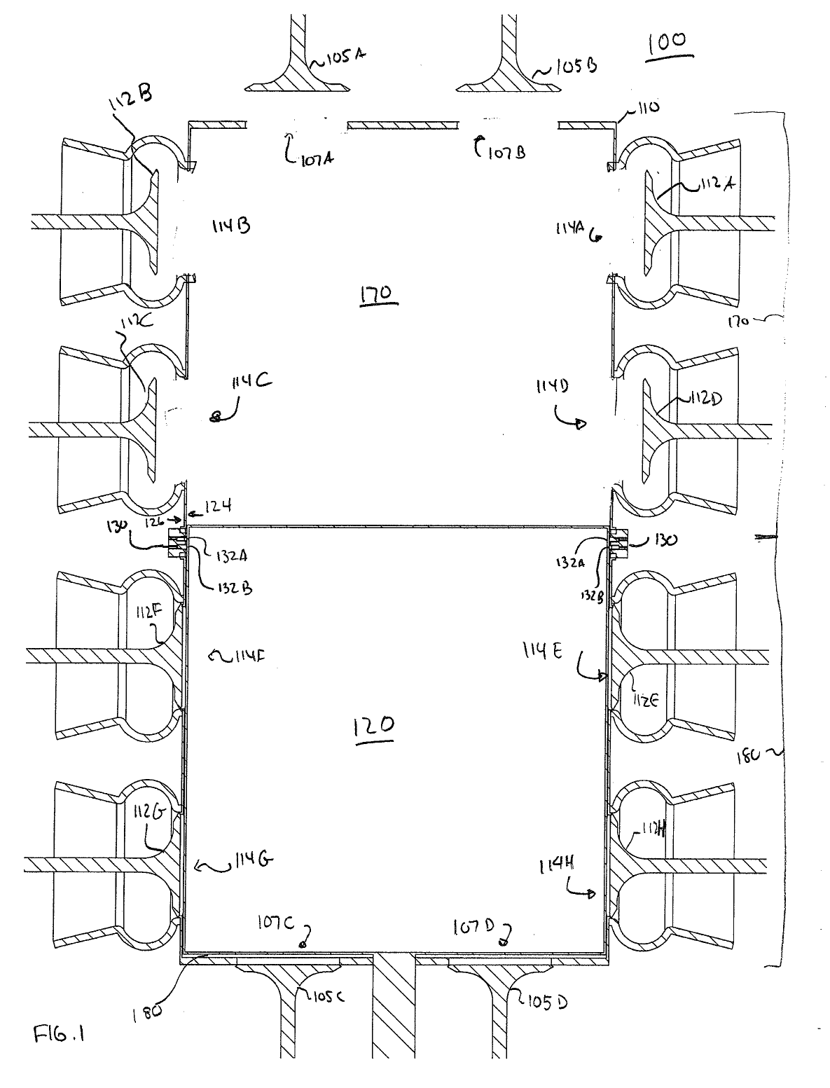

FIG. 1 depicts a cross-section view of a portion of a steam engine 100. The steam engine 100 includes one or more inlet valves 105A-D to a cylinder 110 having inlets 107A-D through which high-pressure, high-temperature steam is admitted into cylinder 110. The cylinder 110 also includes exhaust valves 112A-H, such as for example Unaflow exhaust valves 112C, D, E, and F and auxiliary exhaust valves 112A, B, G, and H. When the exhaust valves are opened, these valves allow exhaust steam to flow through for example the exhaust ports, such as Unaflow exhaust ports 114C, D, E, and F and the auxiliary exhaust ports 112A, B, G, and H. The portion of the steam engine 100 also includes a piston 120, which moves within the cylinder 110. In some example embodiments, the steam engine 100 includes cylinder rings 132A-B and a ring holder 130.

Although the description herein uses a steam engine and, in particular, a Universal Unaflow steam engine, other types of engines may be used as well including reciprocating steam engines, a compound steam engine, a Unaflow steam engine, an internal combustion engine, and any other type of engine.

Before describing the cylinder rings 132A-B further, the following provides a general description of the operation of steam engine 100.

The inlets 107A-D enable steam to flow into the cylinder 110 under the control of inlet valves 105A-D. For example, when the inlet valves 105A-B are open, high-pressure, high-temperature steam is admitted into the upper portion 170 of the cylinder 110, and then the valves 105A-B close such that the steam expands and pushes the piston 120 towards the lower portion 180 of cylinder 110, at which point the piston 120 is at, or near, the bottom dead center of the stroke. At approximately bottom dead center, or slightly before or after, the exhaust valves 112C-D are opened, allowing a portion of the steam to exhaust through the exhaust ports 114C-D. When a Unaflow steam engine is used, the Unaflow steam engine (when compared with a counter-flow steam engine) may have a larger portion of the steam exhausted through the Unaflow exhaust ports, which are farther from the hotter inlet ports than the exhaust ports mounted in, or near, the cylinder head containing the inlet ports, reducing thus the energy loss that results from contact between cooler expanded steam and hotter parts of the cylinder valves.

When the piston is at approximately bottom dead center, the inlet valves 105C-D open to admit high-pressure, high-temperature steam via inlet ports 107C-D into the lower portion 180 of the cylinder 110, driving the piston 120 upward. Also, when the piston 120 is at approximately bottom dead center, auxiliary exhaust valves 112A-B are opened, so that as piston 120 is driven upward, the piston 120 pushes most of the steam remaining in upper cavity 170 out of Unaflow exhaust ports 114C-D and auxiliary exhaust ports 114A-B. After piston 120 covers Unaflow exhaust ports 114C-D, Unaflow exhaust valves 112C-D are closed. After piston 120 covers auxiliary exhaust ports 114A-B, auxiliary exhaust valves 112A-B are closed. Once the piston 120 is driven towards the top of the cylinder 110, the cycle repeats with the opening of inlet valves 105A-B. Although the foregoing provided a general description of an operating mode of a steam engine, other operating modes may be used as well.

The piston 120 may be considered double acting, such that when the piston 120 is at about the bottom dead center of its travel, the inlet valves 105C-D open to admit steam into the lower portion 180 of the cylinder 100, driving the piston 120 upward. And, when the piston 120 is at about the top dead center of its travel, the inlet valves 105A-B open to admit steam into the upper portion 170, driving the piston 120 downward.

The cylinder 110 includes an inner surface 124 and an outer surface 126. In some example embodiments, one or more cylinder rings 132A-B are positioned in annular grooves in the ring holder 130. The one or more cylinder rings 132A-B and the ring holder 130 are positioned between the upper and lower portions 170 and 180 of cylinder 110. Although FIG. 1 depicts a single ring holder 130, other quantities of ring holders may be used as well.

In some example embodiments, the cylinder rings 132A-B are positioned at a so-called “cold region” of cylinder 110. The cold region is typically the region of the cylinder wall proximate to the top of piston 120, when the piston 120 is at or near the bottom dead center portion of the stroke.

In a double acting piston, such as for example piston 120 depicted at FIG. 1, the cold region is at about the middle portion of the cylinder 110. Thus, in the example of FIG. 1, the cold region corresponds to the area of the inner surface 124 proximate to the top of piston 120, when the piston is at, or near, the bottom dead center of the stroke. The cold region in the example of FIG. 1 also corresponds to the region of the inner surface of the cylinder that is proximate to the bottom of piston 120, when the piston is at, or near, the top dead center of the stroke. Regardless of whether the piston 120 is at top dead center or bottom dead center, the cold region, in the example of FIG. 1, corresponds to substantially the same region of the inner surface 124 of piston 120.

The cold region—where the cylinder rings 132A-B and ring holder 130 are positioned—may be a relatively cooler portion of the cylinder 110, when compared to the steam inlets 107A-D through which relatively high-temperature and high-pressure steam enters the cylinder 110. Moreover, the compression of the steam by piston 120 may further contribute to the high temperatures near inlets 107A-D. In a double-acting piston engine, the temperature of the cylinder 110 typically decreases from the inlets 107A-B to the cold region and then increases again when approaching inlets 107C-D.

The cylinder rings 132A-B may be configured in series, i.e., one above the other. The cylinder rings 132A-B may consist of any sealing material including, for example, grey cast iron, ductile iron, steel, and any other suitable material.

The cylinder rings 132A-B are configured to be inserted into the annular grooves of the ring holder 130. While seated in the grooves of the ring holder 130, the cylinder rings 132A-B provide a seal by pushing against the moving, exterior surface of the piston 120. Moreover, the cylinder rings 132A-B and the ring holder 130 may also provide a mechanism from which lubricant may be applied to the piston 120 to reduce friction. Because the cylinder rings 132A-B are located in the cold region of the cylinder 110, the lubricants used in cylinder 120 may operate at a lower temperature, when compared to approaches which do not place the cylinder rings at the cold region. This may enable the inlet steam to be provided at even higher temperatures and pressures, without raising the lubricant to its breakdown temperature. The ability to use increased temperatures and pressures of inlet steam may result in increased power and efficiency for the engine 100. For example, a steam engine may have an inlet steam temperature of about 600 degrees Fahrenheit, which is a temperature at which most lubricants breakdown, but the cold region may have a temperature of about 248 degrees Fahrenheit or less (which may be below the breakdown temperature of some lubricants).

Furthermore, as the piston 120 moves within cylinder 110, the cylinder rings 132A-B push against the moving, exterior surface of the piston 120. The pressure of the cylinder rings 132A-B against the moving piston 120 may be sufficient to prevent gas (e.g., steam) from leaking between the surface of the moving piston 120 and cylinder rings 132A-B. The cylinder rings 132A-B are typically forced toward the moving surface of the piston 120 with sufficient force to exceed the force that tends to push the cylinder rings 132A-B away from the moving surface of piston 120. The force pushing a cylinder ring away from the surface of the piston is approximately the contact area of the ring to the piston multiplied by the average of the pressures above and below the cylinder ring.

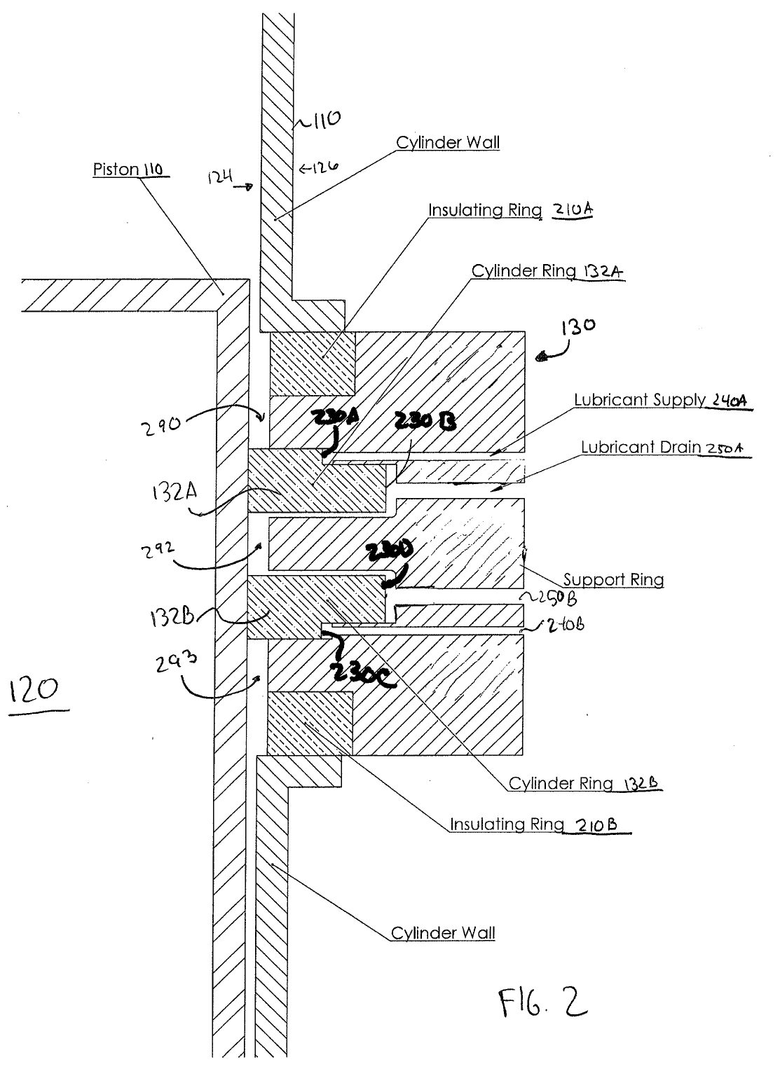

FIG. 2 depicts a closer view of a portion of the cylinder rings 132A-B and the ring holder 130. In the example of FIG. 2, the cylinder rings 132A-B are positioned between the upper cavity 170 and the lower cavity 180 in the so-called cold region of the cylinder 110.

The cylinder rings 132A-B may be annular and shaped to fit securely into the cavity provided by the ring holder 130. The cylinder rings 132A-B and the ring holder 130 may extend around the perimeter of the cylinder, such that the face of each of the cylinder rings extends beyond the inner surface of the cylinder to enable contact with the piston. The face of the cylinder ring refers to the portion of the cylinder ring making contacting with the piston 120. The cylinder rings 132A-B may each include a heel (e.g., heel 230A), which is distal to the face. The cylinder rings 132A-B may be positioned serially, i.e., one above the other. The distance from the inside of the ring annulus to the outside of the ring annulus is typically larger than the maximum distance from the inside cylinder surface to the outside piston surface, so that the piston prevents the ring from sliding out of the ring holder.

In the example embodiment of FIG. 2, the cylinder ring 132A includes a substantially flat face, two parallel sides that extend perpendicularly from the face, and a heel 230A-B. As noted, the cylinder ring may have one or more steps as depicted at 230A-B. Although FIG. 2 depicts a stepped shape for the cylinder ring, other shapes may be used as well.

The ring holder 130 may also include insulating rings 210A-B. The insulating rings 210A-B may be an annular ring around the perimeter of the cylinder 110. The insulating rings 210A-B may each be used to further insulate the cylinder rings 132A-B from the warmer portions of the cylinder 110. The insulating rings 210A-B may comprise any insulating material, although in some implementations the insulating rings 210A-B comprise compacted mineral fiber or silicone rubber covered in stainless steel or covered in titanium foil to withstand high temperatures. For lower temperatures of about 260 degrees Fahrenheit of less, the insulating rings may comprise a compressed vegetable fiber with a foil covering (or without the foil) and phenolic resin or a hard rubber.

In the example of FIG. 2, the cylinder rings 132A-B are stepped, although in some implementations the steps may be omitted. The steps 230A and C are distal to the face of the cylinder rings, and are used as a surface upon which pressure may be applied. For example, pressurized lubricant may be applied via lubricant supply channel 240 (e.g., formed within the ring holder as a tubular enclosed passage). The pressurized lubricant applies a force to the steps 230A and C, which drives the cylinder rings 132A-B towards the moving, exterior surface of the piston 120. The ring holder 130 may also include a return drain, such as channels 250A-B to allow excess lubricant to drain.

FIG. 2 depicts two supply channels 240A-B and two drain channels 250A-B, however other quantities of supply and drain channels may be used as well. The supply and drain channels may be implemented as tubular enclosed passages in a direction radial to the axis of the cylinder.

A pressurized lubricant may be forced to the edge of the cylinder rings 132A-B to lubricate the area where the faces of cylinder rings 132A-B come in contact with piston 120. The pressurized lubricant traveling via channels 240A-B may also apply pressure to the steps 230A and 230C, forcing the cylinder rings 132A-B to make contact at sufficient pressure with the moving piston 120. The lubricant may also be at a higher pressure than the pressure on the power side of the ring (e.g., at region 290) during some portions of the engine cycle in order for the lubricant to flow towards the face of the cylinder rings by flowing between the cylinder ring and the ring holder. Even though the lubricant pressure may at times be substantially higher than the average pressure on the face of the cylinder ring that is in contact with the piston, the fact that the area of the step (e.g., step 230A) is less than the area of the face of the cylinder ring, results in the pressure of the cylinder ring toward the piston to be as low as practical while retaining the cylinder ring in contact with the piston. In some implementations, if it were not for the fact that the areas of steps are less than the areas of the cylinder ring faces, the force of the lubricant on the distal face of the cylinder ring might force the cylinder rings 132A-B to be pressed against piston 120 at a pressure that is higher than necessary, resulting in additional friction between the cylinder ring and the piston (which may result in loss of power and efficiency).

The lubricant at 240A-B may be provided at a constant pressure to force the cylinder rings 132A-B towards the piston 120. Alternatively, the lubricant pressure 240 may be varied.

For example, when the piston 120 cycles through power and exhaust strokes, the pressure within the cylinder varies. During power strokes, the pressure on the power side of a cylinder ring is higher than the pressure on the non-power side. During non-power exhaust strokes, the pressure difference between the power side and non-power side of the cylinder ring is relatively lower, and the total force tending to push the cylinder ring away from the piston is relatively lower. The pressure of the lubricant may be cyclically varied, such that both the lubricant pressure and thus the pressure forcing the cylinder rings 132A-B against the moving surface of the piston 120 are varied to maintain a seal against the piston 120 and provide adequate lubricant flow, while keeping the pressure as low as possible to minimize friction between the cylinder ring and the piston.

When the piston 120 is not in a power portion of the cycle, the pressure at region 290 may decrease. When this is the case, the pressure of the lubricant traveling via lubricant supply channels 240A-B and applying pressure on steps 230A and C may be reduced, without compromising the sealing and lubricating aspects of the cylinder rings 132A-B. When compared to a constant pressure approach, varying the pressure of the lubricant may reduce the amount of pressure exerted by the cylinder rings 132A-B against the surface of the piston 120, which may yield enhanced engine 100 power and efficiency by reducing friction.

The lubricant may be supplied to the space adjacent to the step at a pressure that ensures the steam in the cylinder does not leak significantly along the high-pressure edge of the cylinder ring. The space adjacent to the larger step 230B is drained to allow the lubricant to flow out at a much-reduced pressure. The reduced pressure may be more or less than the pressure in the cylinder on the low pressure side of the sealing ring. Control of the pressure of the lubricant on the smaller step 230A may provide sufficient force on the sealing ring to prevent excessive gas leakage past the cylinder ring. The ratio between the areas of the smaller surface of step 230A and the larger surface 230B may be configured to control the pressure, the flow of lubricant into the cylinder, and/or the leakage of steam from the cylinder into the lubricant flow (which may minimize both leakage and friction).

The lubricant may be a liquid lubricant or a two-phase lubricant consisting of liquid and gas/steam. The lubricant may be one or more of the following: oil, water, steam, gas, finely divided solid or any mixture, solution, or dispersion of these. In some implementations, using a mixture of gas (e.g., steam) with a liquid lubricant or a solid lubricant may enable the cylinder ring to slightly move while seated in the cavities (or grooves) of the ring holder to accommodate the dynamic movement of the piston.

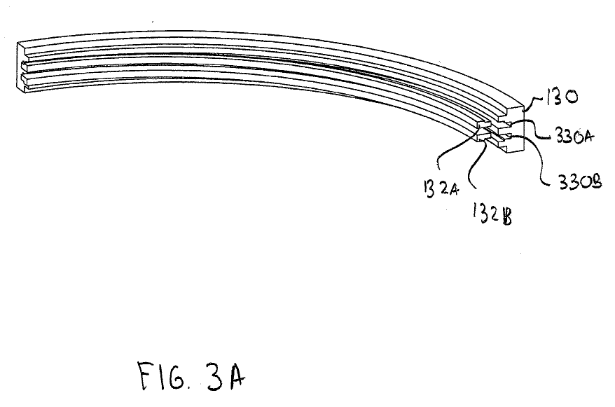

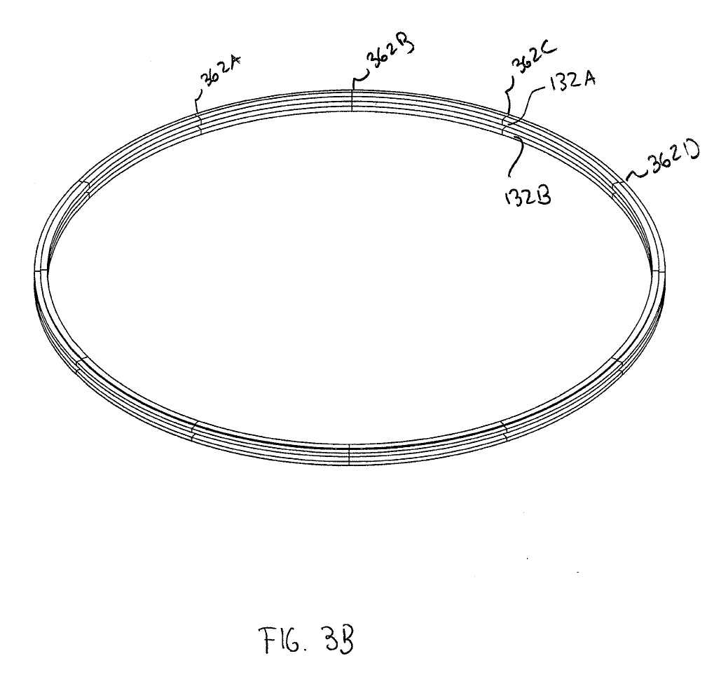

FIG. 3A depicts a portion of cylinder rings 132A-B and ring holder 130. In the example of FIG. 3A, the cylinder rings 132A-B are annular rings having a corresponding steps distal to the face of the cylinder ring. In some implementations, the steps (e.g., steps 230A and C) are each about 25% of the overall thickness of the cylinder ring. The cylinder rings 132A-B are shaped to fit securely into mating groves 330A-B of the ring holder 130. FIG. 3A depicts a portion of the cylinder rings 132A-B, ring holder 130, and grooves 330A-B. However, the cylinder rings 132A-B, ring holder 130, and grooves 330A-B extend around the perimeter of the cylinder 110 (e.g., around the cold region of cylinder 110).

FIG. 3B depicts each of cylinder rings 132A-B. In some implementations, the cylinder rings 132A-B may be segmented 362A-D to form an annular ring, which is inserted into the mated cavity (or groove) of the ring holders to securely hold the cylinder rings. The one or more segments 362A-D may have one or more corresponding gaps between the ends of the segments to allow for the completed rings 132A-B to change circumference in order to maintain a seal while accommodating dynamic motion of the piston and also accommodate variations due to manufacturing tolerances and thermal expansion and contraction. The segmentation of the rings also facilitates assembly and disassembly. The joints between the segments are configured as typical sealing joints, such as for example halving joints, to minimize leakage through the gaps.

Although the cavities of the ring holder 130 into which the cylinder rings are inserted are sized to make close contact with the cylinder rings, the cavities may be configured to provide sufficient space between the surfaces of the rings and ring holder to allow lubricant to flow within the space and flow to the face of each of the cylinder rings.

Although two cylinder rings are depicted FIGS. 1-4, other quantities of cylinder rings may be used as well. Moreover, the use of multiple cylinder rings may divide the pressure drop across each cylinder ring.

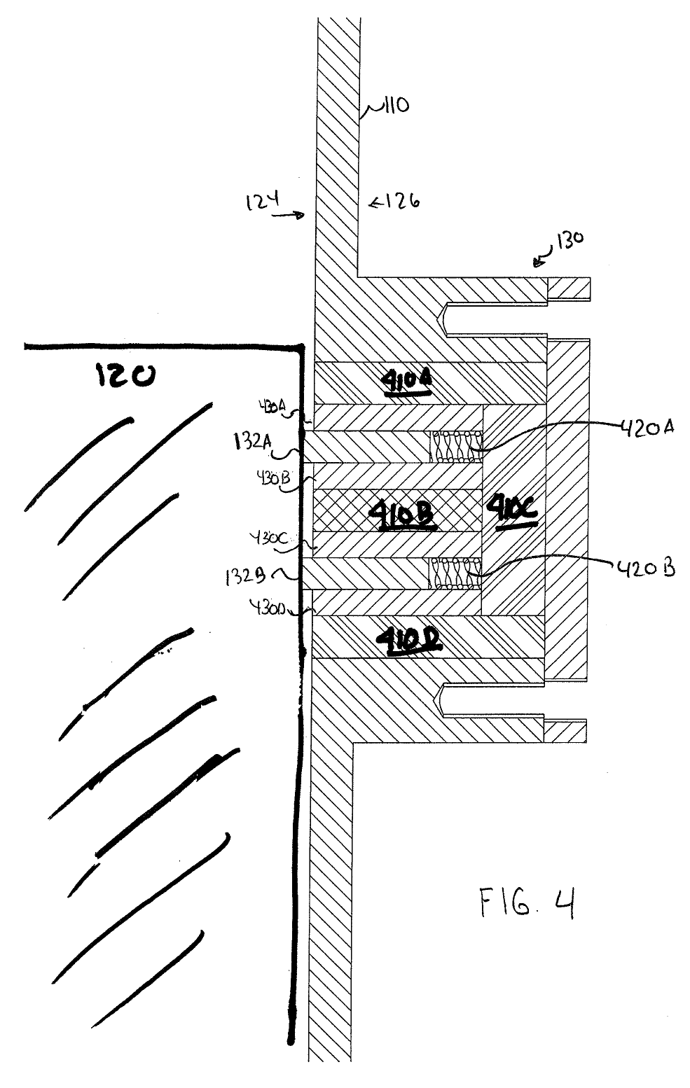

FIG. 4 depicts another example of an implementation of the cylinder rings 132A-B. In the example of FIG. 4, the cylinder rings 132A-B are positioned in the so-called cold region of the cylinder 110. However, cylinder rings 132A-B are forced against the moving surface of the piston 120 using springs 420A-B. Although FIG. 2 and FIG. 4 depict examples of using springs and lubricant, a combination of both may be used as well.

In the example of FIG. 4, the cylinder rings 132A-B also include insulation, such as insulating rings 410A-D. The cylinder rings 132A-B may extend around the perimeter of the cylinder 110, and may also be positioned within the ring holder 130 using spacers, such as for example spacers 430A-D.

In some implementations, the so-called cold region in the middle of the cylinder 110 is further cooled using a coolant. This may be accomplished by a channel extending around the cold region of the arrangements depicted in FIGS. 1-4 through which coolant flows, or by other cooling mechanisms, such as fins cooled by air flow.

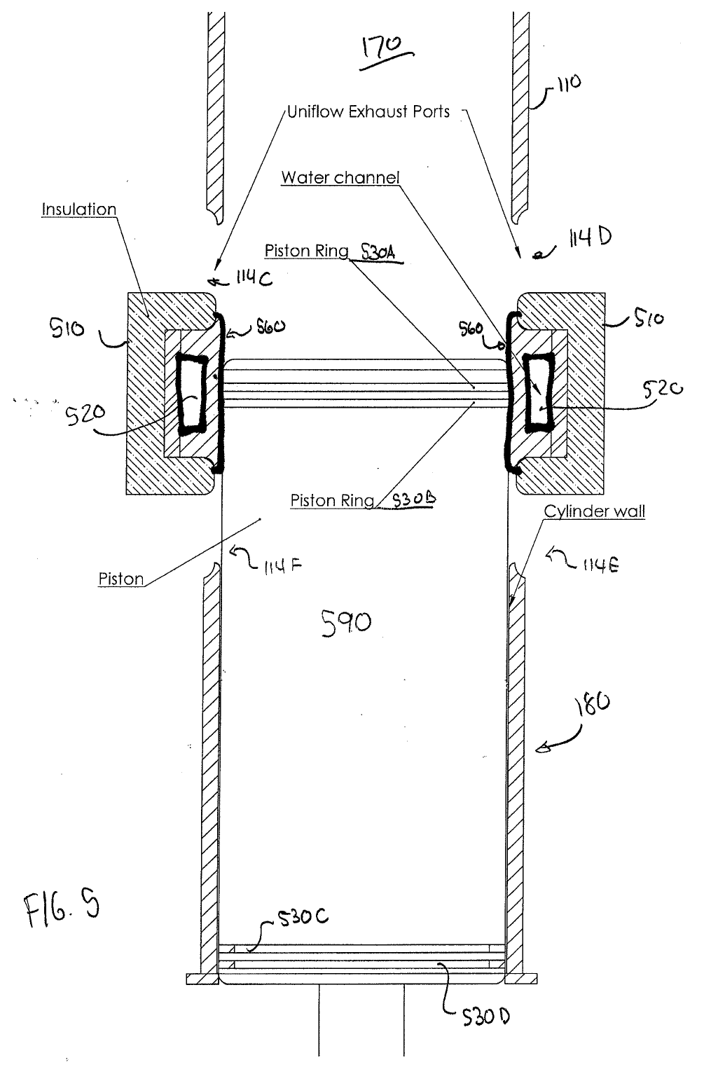

FIG. 5 depicts cylinder 110 further configured to include an insulator 510 and an annular cooling chamber 520, which provides a cool region (e.g., an annular cooling region) on the inner surface of the cylinder 110. The annular cooling chamber 520 may include a coolant to cool the region.

In the configuration of FIG. 5, the cylinder rings are removed from the cold region and replaced with a typical set of piston rings 530A-D located near the top and bottom of the piston 590, although the annular cooling chamber 520 and insulator 510 may be used with cylinder rings as well.

The annular cooling chamber 520 forms a cavity around the interior surface of the cylinder 110. The annular cooling chamber 520 may cool the interior surface of the cylinder 100 at the cold region 560. The cold region 560 forms an annular region around the interior surface of the cylinder 110.

In some implementations, the annular cooling chamber 520 may be insulated from hotter portions of the engine using the insulator 510. The insulator 510 may be implemented as an annular jacket around the annular cooling chamber 520. The insulator 520 may extend around the perimeter of the cylinder wall. The coolant in water channel 520 may be any type of liquid or gas including one or more of the following: water, ethyl glycol, oil, air, and the like. The coolant may be circulated into the annular cooling chamber 520 and cooled by a variety of mechanisms, such as for example a radiator. The coolant cools the surface of the cold region 560 sufficiently so that the piston rings 530A-B are cooled when traversing the cold region 560, which occurs when piston 120 is shortly before, at, and after the bottom dead center.

Shortly before, during, and after piston 120 is at top dead center, piston rings 530C-D traverse cold region 560 and are thus cooled. Each set of piston rings at either the top end of piston 120 (piston rings 530A-B) or the bottom end of piston 120 (piston rings 530C-D) traverses both the cold region toward the center of the cylinder and one of the hotter regions toward the end of the cylinder, and is alternately heated and cooled. Since heating and cooling is not instantaneous, the temperature excursion of the piston rings 530A-D is less than the difference between the extremes of temperature found at the hotter regions and the cold region of the cylinder. In particular, the maximum temperature reached by the piston rings may be substantially less than the maximum temperature reached by the steam in the cylinder or the maximum temperature of the cylinder walls, cylinder ends, piston walls, and/or piston ends. The cooling provided by the coolant in the cooling channel serves to further reduce the maximum temperature reached by lubricant in contact with the piston rings. As a result, the temperature and pressure of the inlet steam may be raised to a higher level without causing the lubricant to exceed the breakdown temperature of the lubricant.

Furthermore, the use of inlet steam at higher temperature and pressure may enable operation of the engine at a higher power and efficiency. For example, in an a typical engine without an annular cooling chamber 520 and a cooling region, the temperature of the piston rings may cycle between a maximum of 310 degrees Fahrenheit and a minimum of 255 degrees Fahrenheit. With the addition of the annular cooling chamber 520, the temperature of the piston rings may cycle between a maximum of 220 degrees Fahrenheit and a minimum of 165 degrees Fahrenheit. This would in turn enable the temperature of the inlet steam to be increased by approximately 150 degrees Fahrenheit without causing the lubricant to exceed the lubricant's breakdown temperature. Although some of the examples described herein provide temperatures, these values are merely examples.

In some of the example embodiments described herein, it may be desirable to maintain the temperature of the cylindrical wall of the piston as low as possible as some or all of the piston wall comes in contact with the cylinder rings or piston rings, and it may also be desirable to keep the temperature of the cylinder rings or piston rings as low as possible. The highest temperatures that the piston will be exposed to may be at the top surface of the piston when the piston is near top dead center, or at the bottom surface of the piston when the piston is near bottom dead center. The piston walls may be kept cooler by increasing the thermal resistance between the top or bottom surfaces of the piston and the cylindrical piston walls. This can be accomplished by inserting a ring of insulating material between the top or bottom surfaces of the piston and the piston walls. The insulating rings are located near the top or bottom ends of the piston walls. In the case where piston rings are used, the insulating ring may be located between the piston ring (or set of rings) and the top (or bottom) surface of the piston that is proximate to the piston rings. This thermal isolation between the top or bottom surface of the piston and the piston wall may also be implemented by constructing the top and bottom surfaces of the piston from material that has a relatively low thermal conductivity while being able to withstand the high temperatures that the ends of the cylinder are exposed to. An example of such a material is a stainless steel alloy with low thermal conductivity.

While the mechanisms described herein are described in the context of double-acting piston engines, the described mechanisms may also be used with single-acting piston engines, including both steam engines and internal combustion engines.

The foregoing description is intended to illustrate but not to limit the scope of the invention, which is defined by the scope of the appended claims. Other embodiments are within the scope of the following claims.

What is claimed:

1. An apparatus comprising:
a cylinder for a reciprocating steam engine, wherein the cylinder further comprises:
a cylinder ring, wherein the cylinder ring includes a face and a heel, wherein the face makes contact with a piston of the reciprocating steam engine, wherein the heel inserts into a cavity formed on an inner surface of the cylinder, wherein the cavity is positioned in a region of the inner surface proximate to a top of the piston, when the piston is at a bottom dead center position.

2. The apparatus of claim 1, wherein the heel includes a first step and a second step, wherein a lubricant under pressure is applied to the first step to force the face towards an exterior surface of the piston.

3. The apparatus of claim 1, wherein the heel of the cylinder ring is coupled to a spring to force the cylinder ring towards an exterior surface of the piston.

4. The apparatus of claim 1 further comprising:
a ring holder comprising the cavity, wherein the ring holder further comprises one or more insulating rings, one or more cylinder rings, and one or more channels to provide at least one of a supply of a lubricant and a drain for the lubricant.

5. The apparatus of claim 4, wherein a pressure of the supply of the lubricant is varied based on the cycle of the reciprocating steam engine.

6. The apparatus of claim 5, wherein the pressure maintains the lubricant at the face of the cylinder ring and maintains a seal between the cylinder ring and the piston.

7. The apparatus of claim 5, wherein the pressure minimizes friction between the cylinder ring and the piston, when a pressure difference between an upper side and a lower side of the cylinder ring varies.

8. The method of claim 1, wherein the region is a cold region located at about a longitudinal center of the cylinder.

9. The apparatus of claim 1 further comprising:
a plurality of insulating rings;
a plurality of cylinder rings; and
one or more ring holders integrated into the cylinder, wherein the one or more ring holders include a plurality of annular grooves shaped to allow insertion of the plurality of cylinder rings.

10. The apparatus of claim 1, wherein the reciprocating steam engine comprises at least one of a unaflow steam engine and a universal unaflow steam engine.

11. The apparatus of claim 1, wherein the region is a relatively cold region of the cylinder, when compared to one or more inlets through which steam is admitted into the reciprocating steam engine.

12. The apparatus of claim 1 further comprising an insulating ring between a wall of the piston and an end of the piston.

13. The apparatus of claim 1 further comprising a piston where an end of the piston is comprised of a material having lower thermal conductivity than a wall of the piston.

14. An apparatus comprising:
a cylinder for a reciprocating steam engine, wherein the cylinder includes an inner surface, the cylinder further comprising:
an insulating ring; and
an annular cooling chamber, wherein the annular cooling chamber extends around the inner surface of the cylinder and contacts a region of the inner surface of the cylinder, wherein the region of the inner surface is proximate to a top of the piston, when the piston is at a bottom dead center position.

15. The apparatus of claim 14, wherein the piston including a piston ring are cooled by the region and annular cooling chamber, when the piston traverses the region.

16. The apparatus of claim 14, wherein the cylinder includes one or more cylinder rings located at the region.

17. The apparatus of claim 14 further comprising an insulating ring between a wall of the piston and an end of the piston.

18. The apparatus of claim 14 further comprising a piston where an end of the piston is comprised of a material having lower thermal conductivity than a wall of the piston.
